(19) United States
(12) Patent Application Publication
(10) Pub. No.: US 2014/0356096 A1
(43) Pub. Date: Dec. 4, 2014

(54) UNITARY CARRIAGE BOLT

(71) Applicant: CALE DILLARD, Saginaw, MI (US)

(72) Inventor: CALE DILLARD, Saginaw, MI (US)

(21) Appl. No.: 13/909,150

(22) Filed: Jun. 4, 2013

(51) Int. Cl. F16B 33/00

(52) U.S. Cl. CPC F16B 33/002
USPC 411/133

(57) ABSTRACT

A unitary carriage bolt that has nibs that will counter sink into a work piece to prevent rotation of the carriage bolt. As the nut of the unitary carriage bolt is tightened down the nibs are forced into any malleable surface. Once the nibs are totally counter sunk into the work piece the unitary carriage bolt cannot be rotated. The nut must first be loosened enough for the nibs to be removed from the work piece before it is rotational.

### BACKGROUND OF THE INVENTION

The present invention is a unitary carriage bolt that has nibs that countersink into a work piece to prevent rotation of the carriage bolt. Carriage bolts are not new to the art. However, a carriage bolt that prevents rotation once counter sunk is new and presents greater utility over any prior art device. One such prior art device is disclosed in U.S. Pat. No. 6,709,211 entitled, “Girt or Purlin Retainer and Method of Using”, issued to Knecht on Mar. 23, 2004 which teaches a threaded shank having a deformable, disk shaped head mounted thereon. This bolt fits into a pair of metal clips that have elongated openings that when aligned the deformable portion fits into the elongated openings thus locking the bolt into place and prevent rotation. This bolt will only work with the clips, giving it limited utility. The present invention will counter sink into any malleable surface and prevent rotation.

Another prior art device is disclosed in U.S. Pat. No. 7,306,418 entitled, “Deforming Member and Captive Fastener Retaining Method”, issued to Kornblum on Dec. 11, 2007 that teaches a fastener that is retained within an opening of a work piece by deforming a portion of an edge of the opening inwardly to prevent removal of the fastener. This is not an anti rotational feature; it teaches an anti removal feature. The instant invention device allows for insertion, anti-rotation and removal. These aspects give the present invention a much greater utility.

Another prior art device is disclosed in U.S. Pat. No. 4,293,256 entitled, “Load Indicating Fastener”, issued to Pamer on Oct. 6, 1981 which teaches an improved fastener that indicates a predetermined preload that has been supplied to the fastener. This device has small teeth on the underside of the fastener head. These teeth are designed to place tension across the head to indicate that the bolt is tight. These teeth act when force is applied to indicate the amount of force that has been applied. Pamer does not teach anti-rotation, just indication of tightening. Here again, the instant invention has a greater utility, in that, it accomplishes it purpose, which is anti rotation, which is not taught by Pamer.

None of the prior art devices have the anti-rotational aspect of the present invention. Once the nibs of the present invention have been countersunk the unitary carriage bolt is completely non rotational. The prior art devices are not.

### THE INVENTION

The present invention is a unitary carriage bolt. The carriage bolt comprises, a flat topped head that has an under surface. There is also a shaft. The shaft comprises an upper portion and a lower portion. The lower portion is threaded and the upper portion is non-threaded. The under surface of the flat topped head and the non-threaded portion have fixedly attached thereto, at least one vertically oriented nib.

### BRIEF DESCRIPTION OF THE DRAWINGS

FIG. 1 is a bottom view of the unitary carriage bolt.

FIG. 2 is a front view of the unitary carriage bolt.

FIG. 3 is a side view the unitary carriage bolt.

### DETAILED DESCRIPTION OF THE DRAWINGS

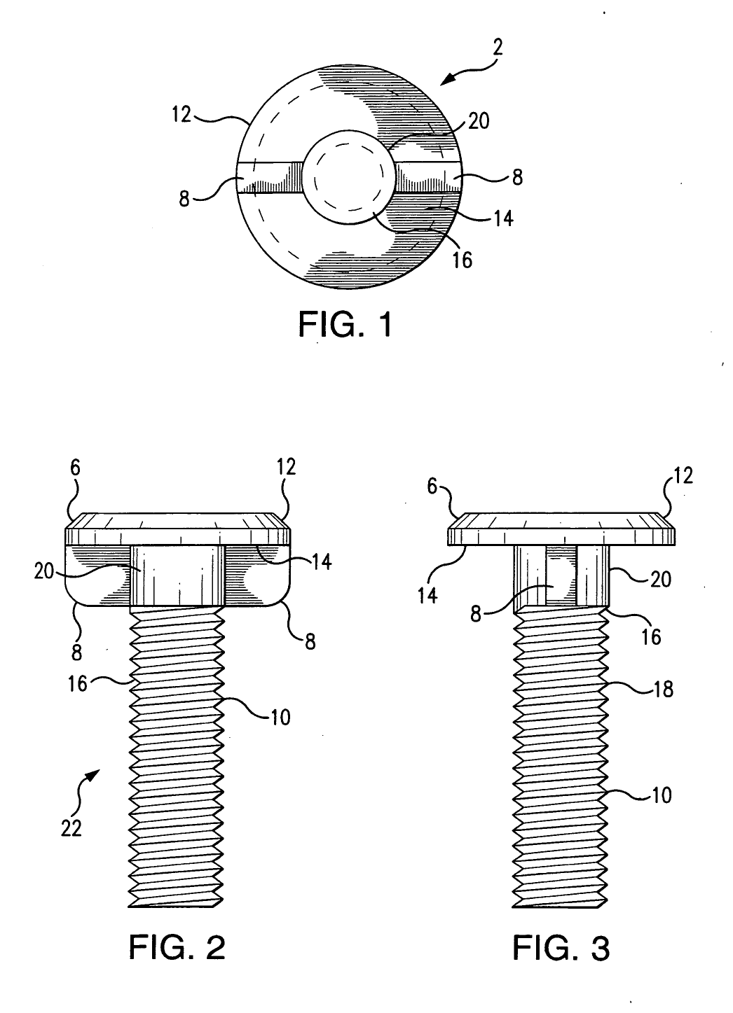

FIG. 1 shows the unitary carriage bolt 2 from the bottom 4. This figure shows the undersurface 14 of the head 12. Also shown is the upper portion 20 of shaft 16. Extending from the undersurface 14 and the upper portion 20 of the shaft 16 is the vertically oriented nib 8. It has been discovered that when the unitary carriage bolt 2 is in place and tightened the nib 8 will countersink into the work material. When the nibs 8 are embedded into the work piece the unitary carriage bolt 2 cannot turn under any circumstances. When the unitary carriage bolt 2 is locked by the nibs 8 it is firmly countersunk into the work piece.

Carriage bolts are common to those skilled in the art and so are their associated problems of rotation well known. They also suffer from rotational issues when being tightened or when tight. The nibs 8 of the present invention once counter sunk into the work piece prevent rotation of the unitary carriage bolt 2. Once the nibs 8 are counter sunk, rotation is impossible without loosening the nut on the unitary carriage bolt 2.

FIG. 2 shows the unitary carriage bolt 2 from the front 22. Here the flat top 6 is clearly shown. Also shown is the upper portion 20 of the shaft 16. This section, the upper portion 20, is not threaded. This upper portion 20 also has the nib 8 portion attached to each side of the shaft 16. The nib 8 is also attached to the undersurface 14 of the head 12. This piece is now unitary. Unitary is defined as of, relating to, based upon, or characterized by unity: monistic. Further, having character of a unit: not divided or discontinuous.

The lower portion 18 has threads 10 and make up the remainder of the shaft 16.

FIG. 3 shows the unitary carriage bolt 2 from the side. The shaft 16 has an upper portion 20 which is not threaded 10. The lower portion 18 is threaded 10. The nib 8 is attached to the undersurface 14 of the head 12 and to the upper portion 20, which is unthreaded of the shaft 16. Again the nib 8 is combined with the undersurface 14 and the upper portion 20 of shaft 16 to form a unitary structure. This unitary structure when countersunk within a work piece becomes non-rotational. The countersunk portion is embedded within the work piece. This creates greater utility over any other prior art device.

The range in length of the present invention is typically 3/16 inch to 14 inches but is not limited by this application. The range in size of the diameter of the present invention is ⅛ inches to 1½ inches but is not limited to this range in the application.

Another advantage of the unitary carriage bolt is that the bolt does not require any pre-applications to allow the counter sinking action. Many prior art examples are available that provide work pieces to be pre-drilled or pre-prepared to assist in a counter sinking application. The present invention requires none. The unitary carriage bolt is simply tightened and as it is tightened the nibs 8 are drawn into the work piece creating an anti-rotational union.

What is claimed is:

1. A unitary carriage bolt, said carriage bolt comprising:
a. a flat topped head having an under surface;
b. a shaft, said shaft comprising an upper portion and a lower portion, said lower portion being threaded, said upper portion being non-threaded;
c. said under surface of said flat topped head, and said non-threaded portion of the shaft having fixedly attached thereto, at least one vertically oriented nib.

2. The unitary carriage bolt as claimed in claim 1 wherein the length ranges from 3/16 inch to 14 inches.

3. The unitary carriage bolt as claimed in claim 1 wherein the diameter ranges from ⅛ inch to 1½ inches.

4. The unitary carriage bolt as claimed in claim 1 wherein said nib does not project into the threaded portion.
